(19) United States
(12) Patent Application Publication
(10) Pub. No.: US 2020/0398088 A1
(43) Pub. Date: Dec. 24, 2020

(54) Safety Harness Assembly

(71) Applicant: Tethrd LLC, Jordan, MN (US)

(72) Inventors: Walter Ernest Power, II, Jordan, MN (US); Gregory Alan Godfrey, Richmond Hill, GA (US); Carl Eugene Kossuth, III, Jordan, MN (US)

(73) Assignee: Tethrd, LLC, Jordan, MN (US)

(21) Appl. No.: 16/449,702

(22) Filed: Jun. 24, 2019

(51) Int. Cl. A62B 35/00

(52) U.S. Cl. CPC A62B 35/0012; A62B 35/0025

(57) ABSTRACT

A safety harness assembly includes an upper cradle and a lower cradle. Each of the upper and lower cradles has a front side, a rear side, a top edge, a bottom edge, a first lateral edge and a second lateral edge. The upper cradle is positioned above the lower cradle such that the bottom edge of the upper cradle is positioned adjacent to the top edge of the lower cradle. The upper cradle is positionable against a lower back of a person and the lower cradle is positionable against upper legs of a person. A plurality of bridge connectors is attached to the upper and lower cradles and engage a bridge rope. An adjustment member is attached to and extends between the upper and lower cradles. The adjustment member has an adjustable length to selectively alter a distance between the upper and lower cradles.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The invention relates to safety harnesses and in particular those safety harnesses used by hunters during saddle hunting. Saddle hunting is a type of hunting whereby the hunter is typically positioned in a tree while standing on a small tree stand, foot platform, steps or the like. The hunter utilizes the safety harness for safety reasons as well to allow the hunter to move around the tree, using the tree stand for leverage, while searching for and shooting at game.

### (2) Description of Related Art Including Information Disclosed Under 37 CFR 1.97 and 1.98

The disclosure and prior art relates to saddle hunting harness devices and more particularly pertains to a new saddle hunting harness device for allowing a user of a harness to adjust the harness sections relative to each other such that the sections are more comfortable for walking to and from a hunting area as well as for sitting in while the user is in their hunting location.

### BRIEF SUMMARY OF THE INVENTION

An embodiment of the disclosure meets the needs presented above by generally comprising an upper cradle and a lower cradle. Each of the upper and lower cradles has a front side, a rear side, a top edge, a bottom edge, a first lateral edge and a second lateral edge. The upper cradle is positioned above the lower cradle such that the bottom edge of the upper cradle is positioned adjacent to the top edge of the lower cradle. The upper cradle is configured to be positionable against a lower back of a person and the lower cradle is configured to be positionable against upper legs of a person. A plurality of bridge connectors is attached to the upper and lower cradles and is configured to engage a bridge rope. An adjustment member is attached to and extends between the upper and lower cradles. The adjustment member has an adjustable length to selectively alter a distance between the upper and lower cradles.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a safety harness assembly according to an embodiment of the disclosure.

FIG. 2 is a rear view of an embodiment of the disclosure.

FIG. 3 is a front view of an embodiment of the disclosure.

FIG. 4 is a side view of an embodiment of the disclosure.

FIG. 5 is a side view of an embodiment of the disclosure.

FIG. 6 is a side in-use view of an embodiment of the disclosure.

FIG. 7 is a front view of an embodiment of the disclosure including a bridge rope.

### DETAILED DESCRIPTION OF THE INVENTION

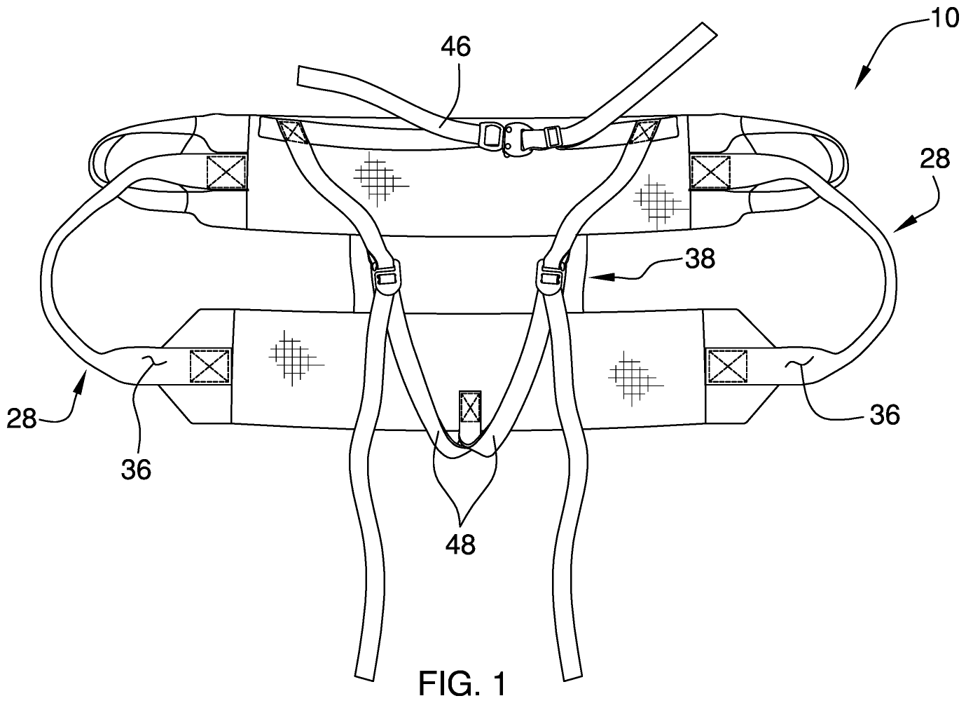

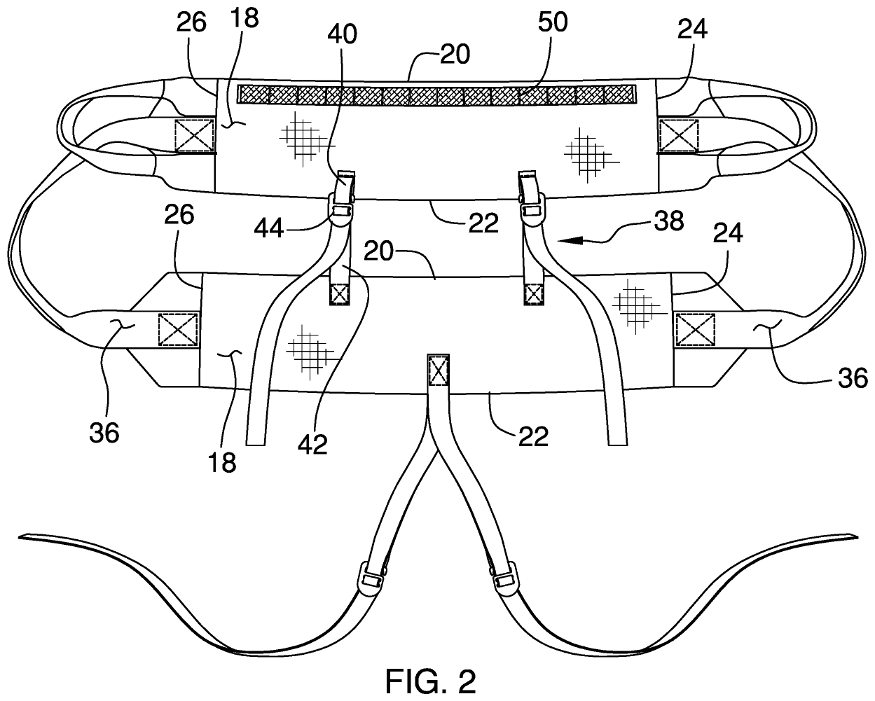

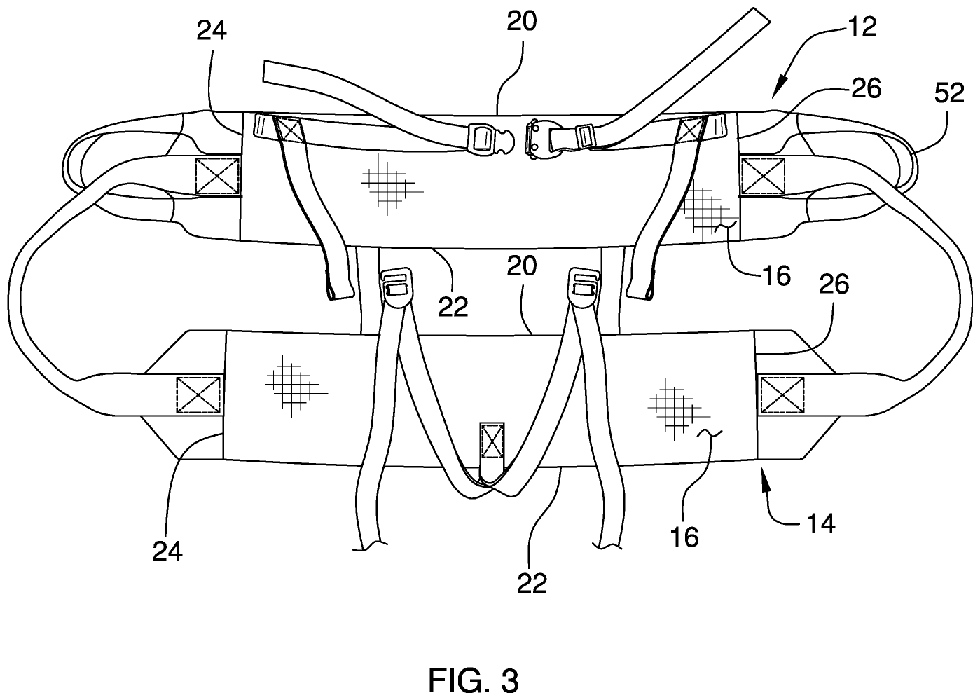

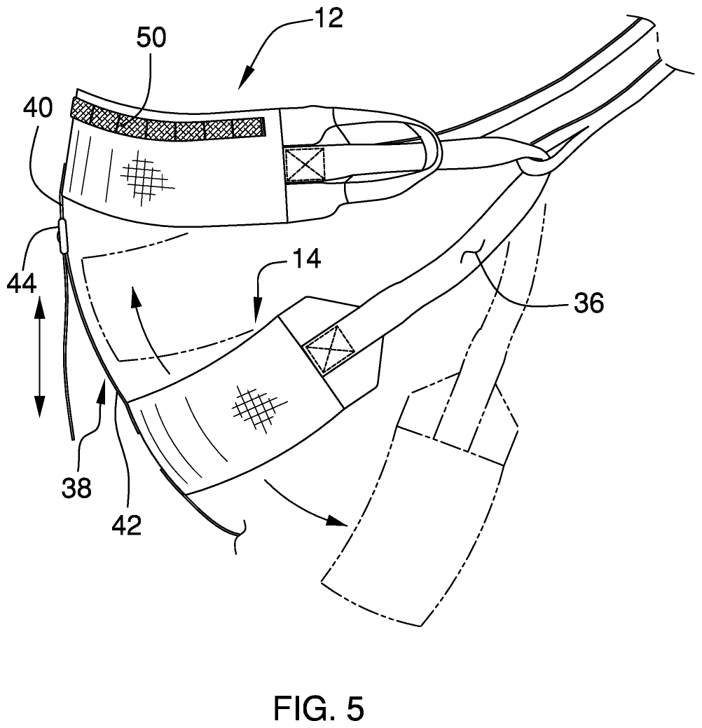

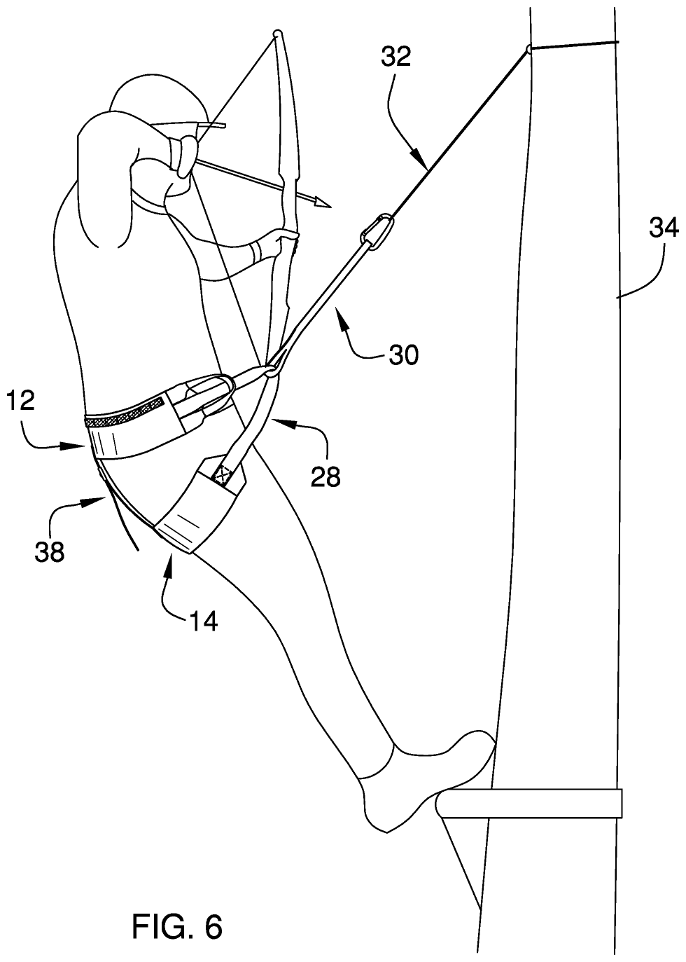

With reference now to the drawings, and in particular to FIGS. 1 through 7 thereof, a new saddle hunting harness device embodying the principles and concepts of an embodiment of the disclosure and generally designated by the reference numeral 10 will be described.

As best illustrated in FIGS. 1 through 7, the safety harness assembly 10 generally comprises an upper cradle 12 and a lower cradle 14. Each of the upper 12 and lower 14 cradles has a front side 16, a rear side 18, a top edge 20, a bottom edge 22, a first lateral edge 24 and a second lateral edge 26. The upper cradle 12 is positioned above the lower cradle 14 such that the bottom edge 22 of the upper cradle 12 is positioned adjacent to the top edge 20 of the lower cradle 14. The upper cradle 12 is configured to be positionable against a lower back of a person and the lower cradle 14 is configured to be positionable against upper legs of a person.

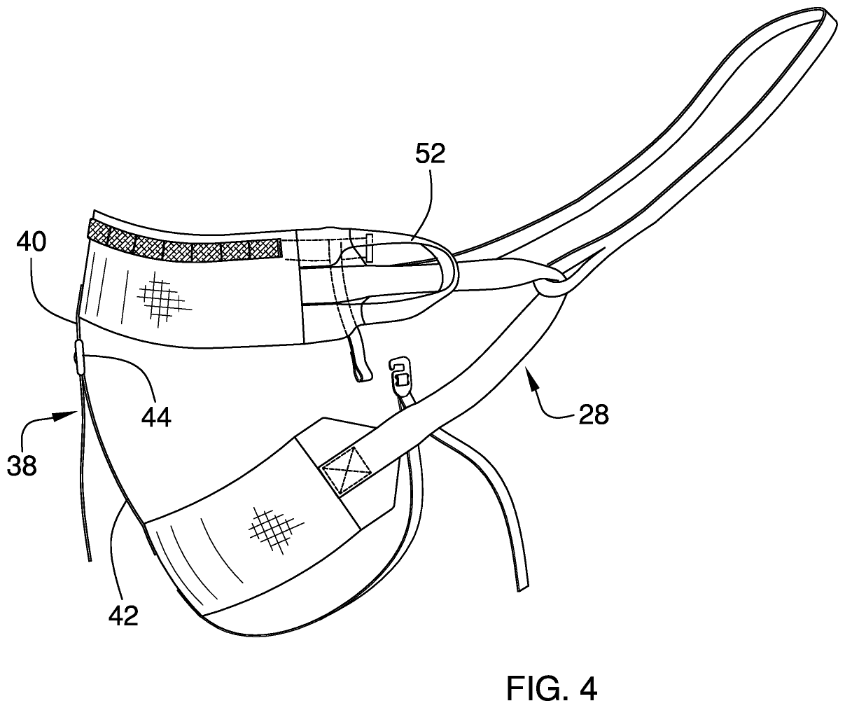

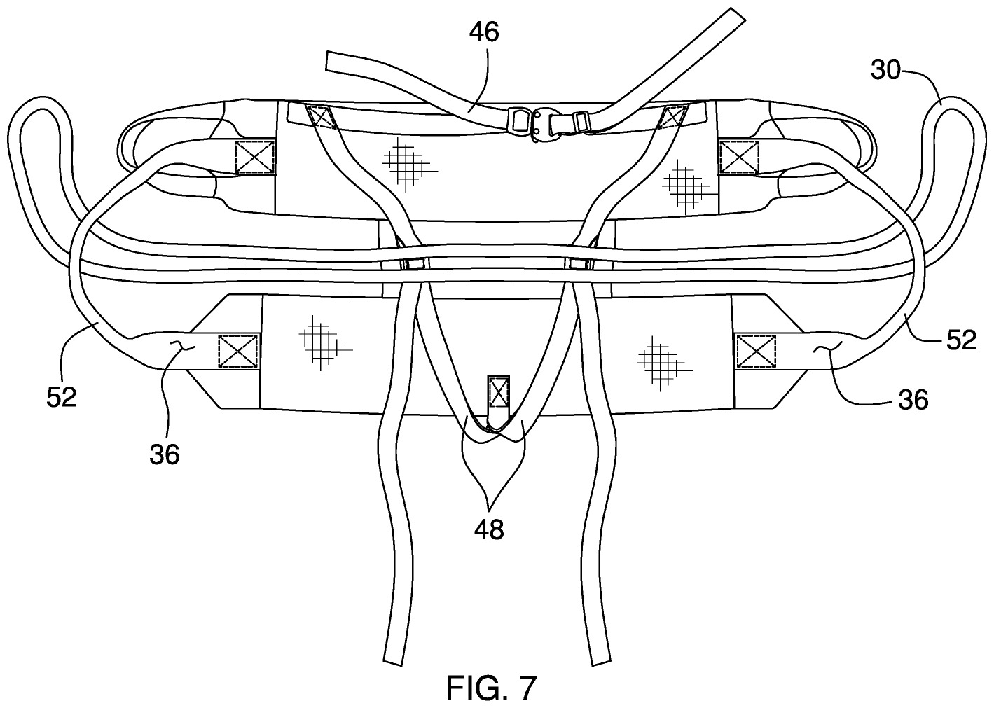

A plurality of bridge connectors 28 is attached to the upper 12 and lower 14 cradles and is configured to engage a bridge rope 30, used to secure the assembly 10 to a line 32, typically comprising a rope, coupled to a tree 34. The bridge rope 30 may comprise a rope or webbing. As can be seen in FIG. 1, in particular, each of the upper 12 and lower 14 cradles may comprise a panel of unitary structure. However, the upper 12 and lower 14 cradles may be comprised of a closed loop strap material as shown in U.S. Pat. No. 4,396,091 and it should be understood that the loop strap material may include a pair of loop straps such that the upper cradle 12 comprises two straps and the lower cradle 14 comprises two straps. Also, the upper 12 and lower 14 cradles may be comprised of a closed loop strap having fabric panels positioned thereon to increase their height from the respective ones of top edges 20 to the bottom edges 22 to increase comfort by increasing surface area. As is understood in FIG. 1, the bridge connectors 28 function to couple the upper 12 and lower 14 cradles together to form and define a closed loop. The bridge rope 30 shown in FIG. 4, while attached to the bridge connectors 28, may also be comprised of a closed loop as shown in FIG. 7.

The plurality of bridge connectors 28 may include a pair of saddle straps 36. One of the saddle straps 36 extends between and is attached to the first lateral edges 24 of the upper 12 and lower 14 cradles, and another of the saddle straps 36 extends between and is attached to the second lateral edges 26 of the upper 12 and lower 14 cradles. The saddle straps 36 may be constructed out of any conventional, flexible strapping or webbing material though rope material may be utilized instead. The saddle straps 36 will each be flexible and have a length from about 6.0 inches to 30.0 inches.

An adjustment member 38, which may include a pair of adjustment members 38, is attached to and extends between the upper 12 and lower 14 cradles. The adjustment members 38 each have an adjustable length to selectively alter a distance between the upper 12 and lower 14 cradles such that a selected distance between the upper 12 and lower 14 cradles is releasably maintained by the adjustment member 38. The adjustment members 38 are spaced from each other and are spaced from the first 24 and second 26 lateral edges of the upper 12 and lower 14 cradles. The distance between the first 24 and second 26 lateral edges and a closest one of the adjustment members 38 is typically 6.0 inches or more. A distance between the adjustment members 38 is greater than 4.0 inches if only two of the adjustment members 38 is utilized. However, it should be understood that more than two adjustment members 38 may be utilized though there would generally be little reason to include more than three adjustment members 38.

The adjustment members 38 may include, for example, a first portion 40 attached to the upper cradle 12 and a second portion 42 attached to the lower cradle. The first portion 40 may be attached to the rear side 16 of the of the upper cradle 12 and the second portion 42 may be attached to the rear side 16 of the lower cradle 14 as shown in the Figures though the locations of the first 40 and second 42 portions relative to the upper 12 and lower 14 cradles is not critical to the assembly 10. Each of the first 40 and second 42 portions may comprise conventional strap material used with safety harnesses. A buckle 44 adjustably secures together the first 40 and second 42 portions. The adjustment members 38 may be cinched tightly so that the top edge 20 of the lower cradle 14 abuts the bottom edge 22 of the upper cradle 12. This configuration would be used, for instance, while the user of the assembly 10 is walking so that the lower cradle 14 is not hanging freely and to abut, rub against, and irritate the user's legs but will instead be positioned on the buttocks adjacent to the lower back. By pulling the lower cradle 14 upwardly tight against the upper cradle 12, the lower cradle 14 will also not easily catch on underbrush while the user moves through the underbrush.

As with conventional harnesses, additional securing means may be employed to further engage the user. Thus, a waist belt 46 is attached to the upper cradle 12 and will usually be is attached to the front side 16 of the upper cradle 12. Furthermore, a pair of leg straps 48 may be attached to and extend between the upper 12 and lower 14 cradles. The leg straps 48 are attached to the front sides 16 of the upper 12 and lower 14 cradles or may be attached to the lower cradle 14 and the waist belt 46. The leg straps 48 may also be attached to the saddle straps 36.

Additional structure on the harness may include conventional loops or connectors 50 for connecting additional articles to the assembly 10. For example, a variety of buckles and hook may be used with typical MOLLE type connectors that are insertable into MOLLE type strapping 14. MOLLE, which may also be referred to as PALS, stands for, respectively, modular lightweight load-carrying equipment and pouch attachment ladder system. These labels are often interchangeable and define a ubiquitous coupling arrangement whereby a strap is attached to an article at approximately 1.5 inch increments to form closed loops between the attachment points. The closed loops are then used for receiving clips, hooks, other straps, or connectors. However, any variety of conventional attachments for hunting type safety harnesses may be included.

Handles 52 may be attached to the upper cradle 12 and are positioned such that the saddle straps 36 are positioned forward of the handles 52. The handles, formed of strapping, rope, or other flexible material, may be used for manipulation by the user for receiving other safety ropes, articles to be transported and the like.

In use, the user typically attaches the bridge rope to the assembly 10 and then steps into the assembly 10 as it lies on the ground with the bridge rope 30 to the front and the upper 14 and lower 16 cradles to the rear. The assembly 10 is lifted and the waist belt 46 buckled and cinched so that the upper cradle 12 is on positioned at the base of the lower back. The adjustment members 38 are typically cinched tight so that the lower cradle 14 is not hanging loosely and the leg straps 48 are secure in place. The bridge rope 30 may be tied off so that it is not freely hanging while walking to a desired destination. When the user enters a tree, the bridge line 30 is secured to the tree line 32 and lower cradle 14 is lowered, relative to the upper cradle 12, with the adjustment members 38 until it is positioned where desired by the user. This distance can vary considerably as the positioning can be above the lower part of the buttocks to a position between the knees and the buttocks depending on the comfort of the user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A safety harness assembly configured to be used by a person while saddle hunting, the safety harness assembly comprising:
an upper cradle and a lower cradle, each of the upper and lower cradles having a front side, a rear side, a top edge, a bottom edge, a first lateral edge and a second lateral edge, the upper cradle being positioned above the lower cradle such that the bottom edge of the upper cradle is positioned adjacent to the top edge of the lower cradle, the upper cradle being configured to be positionable against a lower back of a person, the lower cradle being configured to be positionable against upper legs of a person;
a plurality of bridge connectors being attached to the upper and lower cradles and being configured to engage a bridge rope;
an adjustment member being attached to and extending between the upper and lower cradles, the adjustment member having an adjustable length to selectively alter a distance between the upper and lower cradles.

2. The safety harness assembly according to claim 1, wherein the plurality of bridge connectors comprises a pair of saddle straps, one of the saddle straps extending between and being attached to the first lateral edges of the upper and lower cradles, another of the saddle straps extending between and being attached to the second lateral edges of the upper and lower cradles.

3. The safety harness assembly according to claim 1, wherein said adjustment member includes:
a first portion attached to the upper cradle, the first portion being attached to the rear side of the of the upper cradle;
a second portion attached to lower cradle, the second portion being attached to the rear side of the lower cradle; and
a buckle adjustably securing together the first and second portions.

4. The safety harness assembly according to claim 1, further including:
a waist belt being attached to the upper cradle, the waist belt being attached to the front side of the upper cradle; and
a pair of leg straps being attached to and extending between the upper and lower cradles.

5. The safety harness assembly according to claim 2, wherein the adjustment member includes:
a first portion attached to the upper cradle, the first portion being attached to the rear side of the of the upper cradle;
a second portion attached to lower cradle, the second portion being attached to the rear side of the lower cradle; and
a buckle adjustably securing together the first and second portions.

6. The safety harness assembly according to claim 5, wherein the adjustment member includes a pair of adjustment members wherein each of said adjustment members are spaced from the first and second lateral edges a distance of at least 6.0 inches.

7. The safety harness assembly according to claim 6, wherein a combination of the upper and lower cradles and the bridge connectors defines a closed loop.

8. The safety harness assembly according to claim 1, wherein the adjustment member includes a pair of adjustment members wherein each of said adjustment members are spaced from the first and second lateral edges a distance of at least 6.0 inches.

9. The safety harness assembly according to claim 8, wherein a combination of the upper and lower cradles and the bridge connectors defines a closed loop.

10. The safety harness assembly according to claim 1, wherein a combination of the upper and lower cradles and the bridge connectors defines a closed loop.

11. A safety harness assembly configured to be used by a person while saddle hunting, the safety harness assembly comprising:
an upper cradle and a lower cradle, each of the upper and lower cradles having a front side, a rear side, a top edge, a bottom edge, a first lateral edge and a second lateral edge, the upper cradle being positioned above the lower cradle such that the bottom edge of the upper cradle is positioned adjacent to the top edge of the lower cradle, the upper cradle being configured to be positionable against a lower back of a person, the lower cradle being configured to be positionable against upper legs of a person;
a plurality of bridge connectors being attached to the upper and lower cradles and being configured to engage a bridge rope, a combination of the upper and lower cradles and the bridge connectors defines a closed loop, the plurality of bridge connectors comprising a pair of saddle straps, one of the saddle straps extending between and being attached to the first lateral edges of the upper and lower cradles, another of the saddle straps extending between and being attached to the second lateral edges of the upper and lower cradles;
a pair of adjustment members, each of the adjustment members being attached to and extending between the upper and lower cradles, the adjustment members each having an adjustable length to selectively alter a distance between the upper and lower cradles, the adjustment members being spaced from the first and second lateral edges a distance of at least 6.0 inches, each of the adjustment members including;
a first portion attached to the upper cradle, the first portion being attached to the rear side of the of the upper cradle;
a second portion attached to lower cradle, the second portion being attached to the rear side of the lower cradle;
a buckle adjustably securing together the first and second portions;
a waist belt being attached to the upper cradle, the waist belt being attached to the front side of the upper cradle; and
a pair of leg straps being attached to and extending between the upper and lower cradles.
